(19) United States
(12) Patent Application Publication
(10) Pub. No.: US 2012/0272844 A1
(43) Pub. Date: Nov. 1, 2012

(54) HORIZONTAL COMPACTOR FOR LANDSCAPING WASTE

(76) Inventor: Todd Graus, Jackson, WY (US)

(21) Appl. No.: 13/457,876

(22) Filed: Apr. 27, 2012

Related U.S. Application Data
(60) Provisional application No. 61/479,481, filed on Apr. 27, 2011.

(51) Int. Cl. B30B 15/00; B30B 15/32; B30B 1/18; B30B 15/30; B30B 9/30

(52) U.S. Cl. 100/215; 100/246; 100/280; 100/289

(57) ABSTRACT

A portable compactor for landscape waste formed as a generally rectangular box, extending from a gate at a front end to a closed second end. An opening in top of the box allows waste to be placed in an internal compaction chamber and a compaction plate disposed inside the box moves on parallel threaded drive rods extending along either side of the compactor to compact inserted material against the gate. Following compaction, the plate may be reversed to move away from the gate to provide additional space for insertion of waste. When full, the gate may be opened and the plate advanced to push waste out of the compaction chamber where it can be further used, disposed of or bagged for conversion to silage. The system may be sized to allow for installation in the bed of a pick-up truck, or on a small flatbed or trailer.

### CROSS-REFERENCE TO RELATED APPLICATION

This application claims the benefit of U.S. Provisional Application No. 61/479,481, filed Apr. 27, 2011, the disclosure of which is incorporated herein by reference in its entirety.

### TECHNICAL FIELD

The present invention relates to apparatus and systems for compacting materials.

### BACKGROUND

Typical trash or waste compactors stand upright and use hydraulics to create the force to compact the material placed therein. The use of hydraulics while providing force for compacting introduces limitations into the designs. For example, such compactors may require a secondary hydraulically operated emptying mechanism to remove compacted material from the device, or may require a user to remove the compacted material directly either by physical labor or using a secondary piece of equipment such as a pallet jack or a forklift.

Hydraulically operated compactors may also be constrained in the size as the overall length of such a compactor may be required to be at least twice the length of the stroke of the piston used to create the compacting force. As a result, small scale portable compactors often have a high device weight to compaction ratio. Compactors that use hydraulics may be subject to hydraulic spills due to problems in hydraulic fittings or lines occurring during use. With portable devices, this can lead to accidental hydraulic spills onto the ground at locations where clean up may be problematic.

A portable compactor for landscaping waste that uses a compaction mechanism other than hydraulics would be an improvement in the art. Such a system that has a low space requirement to compaction capacity, which would allow it to fit in the bed of a pickup truck, would be a further improvement in the art.

### SUMMARY

The present invention includes portable compactors for landscape waste. In one illustrative embodiment, such a compactor is formed as a generally rectangular box, extending from a gate at a front end to a closed second end. An opening in top of the box allows waste to be placed in an internal compaction chamber and a compaction plate disposed inside the box moves on parallel threaded drive rods, such as worm gears, extending along either side of the compactor to compact inserted material against the gate. Following compaction, the plate may be reversed to move away from the gate to provide additional space for insertion of waste. When full, the gate may be opened and the plate advanced to push waste out of the compaction chamber it can be further used, disposed of or bagged for conversion to silage. The system may be sized for installation in the bed of a pick-up truck.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIG. 1 is a side perspective schematic view of a portable landscaping waste compactor system in accordance with one aspect of the present invention.

FIG. 2 is a top schematic view of the system of FIG. 1.

FIG. 3 is a perspective cutaway rear view of a portion of a second system in accordance with the present invention, depicting some additional details thereof.

FIG. 4 is a rear schematic view of the system of FIG. 1.

FIG. 4A is a rear schematic view of the layout for drive components of another illustrative embodiment of a system in accordance with the present invention.

FIG. 5 is a front schematic view of the system of FIG. 1.

### DETAILED DESCRIPTION

The present invention relates to apparatus, systems and methods related to portable landscape waste compactors. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention.

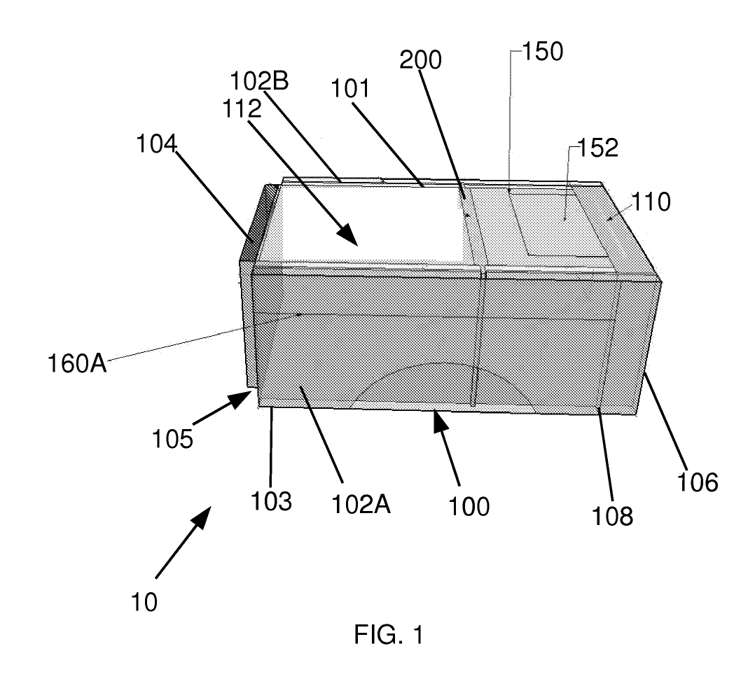

Referring to FIGS. 1 through 5, one embodiment of a portable compactor system 10 for landscape waste in accordance with the principles of the present invention is depicted. The portable compactor 10 is formed as a generally rectangular box 100, extending from a gate 104 at a front end to a closed second end 106, with two opposite sides 102A and 102B, a bottom 103 and a top 101. Internally, the box 100 has two chambers; a smaller mechanical chamber 110 defined by second end 106 and an internal end wall 108. Mechanical chamber 110 may contain the motor(s) and gearing for the system 10.

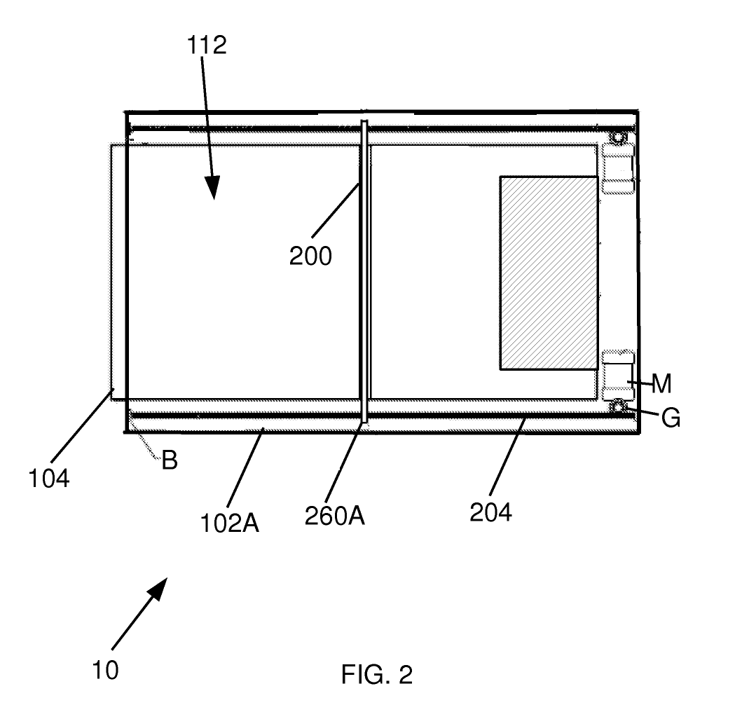

A larger compaction chamber 112 is defined by the internal end wall 108 and gate 104, as well as sides 102A, 102B bottom 103 and top 101. An opening 150 with a hinged lid 152 in top 101 allows waste to be placed in the compaction chamber 112. A compaction plate 200 is disposed inside the compaction chamber 112. Parallel slots 160A and 160B may be present in the opposite sidewalls 102A and 102B to provide a track along which the compaction plate 200 may move. Such slots may be formed as grooves or channels in the sides that are parallel to the long axis of the chamber 112 and tabs 260 may extend therein from the compaction plate 200 (FIG. 2).

The compaction plate 200 may be formed from two or more separate members each having a front face which align in a generally common vertical plane to form a continuous front face with an open seam in between. A shear pin may be placed in receiving slots on the rear of the member to maintain the alignment therebetween. This can allow for some relative motion between the individual portions of the compaction plate. Where present, each section may include tabs 260 and the corresponding drive structures as discussed further herein.

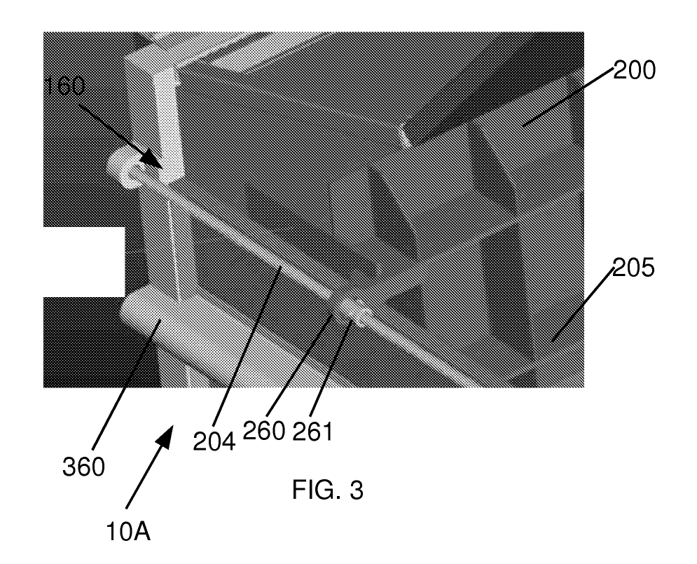

As depicted in the embodiment of system 10A in FIG. 3, a compaction plate 200 may include reinforcing walls and ridges 205 formed as a pattern on the back surface thereof. Additionally, extending forwards from the compaction plate 200 at either side thereof may be a channel shield 203 formed as a planar member having a long axis orthogonal to the face of the compaction plate 200. As depicted, the channel shield 203 may be attached to plate 200 at tab 260. Each channel shield 203 is positioned over the respective parallel slot 160 (although not depicted in the cutaway drawing, the position of channel 160 in relation to the channel shield 203 is generally indicated by arrow 160). As compaction plate 200 is moved forward for compaction, the channel shield moves forward with it and covers the portion of slot 160 in front thereof to prevent compaction of material inserted into the compaction chamber 112 into the slots 160.

FIG. 3 further depicts that a second set of channels 360 and the associated structures may be disposed in the sidewall below allowing for movement and support of the compaction plate 200 at two points on each opposite side. As depicted, an outer surface of the channel may be covered by an external housing.

It will be appreciated that the box 100 may be constructed of a suitable size to allow the system 10 to be placed or mounted in the bed of a pick-up truck. In other installations, such a system could be mounted on a flatbed truck, on a trailer for towing landscaping equipment, or placed in a fixed location (as for example an equipment shed at a golf course).

As best depicted in FIG. 2, a set of parallel linear actuators or threaded drive rods or screws 204 may extend along the compactor system 10. In the depicted embodiment, two parallel drive screws are disposed inside the slots 160A and 160B, along the opposite sidewalls of the internal compaction chamber, each rod 204 passing through a threaded receiver (261, FIG. 3) in the respective tab 260 of the compaction plate 200. As each screw is rotated, the plate is moved along in the desired direction, responsive to the rotation. At either end, each drive rod 204 may be disposed in a bearing B to allow rotation. In one illustrative embodiment, the threaded drive rods are configured so that when rotated to moved the compaction plate 200 towards gate 104 and compact any material placed in the center, the rods 204 are in tension and the force on plate 200 acts to pull the plate 200 in the desired direction, and when rotated in the opposite direction to move plate 200 away from gate 104, the force on plate 200 acts to pull the plate 200 away from gate 104.

The parallel drive rods 204 may be ACME or BALL threaded drive rods, may be worm drive screws, screw jacks or other suitable rods as known to those of skill in the art. It will be appreciated that although the depicted embodiment uses two oppositely disposed parallel drive rods 204, a different number may be used as required for a specific application. For example, embodiments having four drive rods 204, arranged as two on either side of compaction plate 200, nearer the top and bottom thereof may be used. For example, in embodiments where the compaction plate 200 is formed from two separate members such as an upper member and a lower member joined by a shear pin, each of the upper member and lower member may have two drive rods 204 associated therewith for a total of four. Further, embodiments with three drive rods 204, arranged as depicted in the FIG. 2, with a third drive screw 204 disposed in the bottom 103 of compactor system 10 and interacting with plate 200 may be advantageous for certain applications.

It will be appreciated that as each drive rod 204 resides in a parallel slot 160 along the length of the compaction chamber 112, for each number of worm drives there will be a corresponding number of parallel slots 160. Additionally, for some embodiments, there will be a corresponding number of channel shields 203 extending from compaction plate 200 at each slot 160.

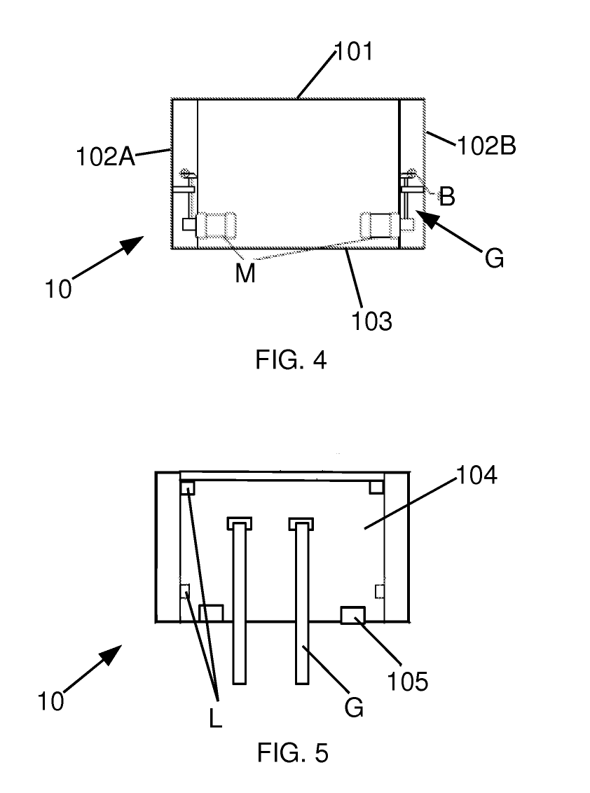

As depicted in FIG. 4, the mechanical chamber 110 may contain one or more motors M and gearing linkage G for providing power to rotate the threaded drive rods 204. As depicted, two motors M may be used, one for each drive. It will be appreciated that any suitable linkages or motors may be used. In the present embodiment, two 12 volt electrical motors are used, allowing the compactor system 10 to operate on the power of a vehicle in which the compactor system 10 is placed.

In an alternative embodiment, each threaded drive rod may be attached to a sprocket or wheel for receiving a chain or belt which is turned by a corresponding wheel or sprocket attached to a motor. This can allow for a single motor M to be used to provide power to two or four drive rods 204. In one embodiment, the motor M may be a 24 volt electric motor which can be powered by two 12 volt batteries wired in series. This allows a twelve volt primary vehicle, such as pickup truck, to recharge the batteries using onboard systems while providing sufficient torque for operation. FIG. 4A depicts a set of mounts 401 for attachment of the wheels or sprockets to the threaded rods 204 of a system using four threaded drive rods and a single motor attached to the motor mount MM.

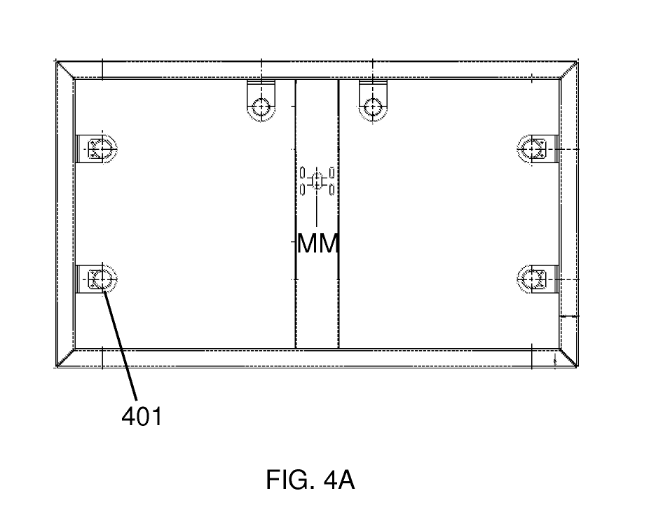

FIG. 5 depicts the front end of the compactor system 10, with gate 104 in a closed position. A hinge 105 along the bottom allows the gate 104 to rotate downwards. One or more latches L may be used to retain the gate in a closed position. One or more legs G may be hingedly attached to gate 104, such that upon opening the legs extend to the ground outside the bed of a pickup in which the system 10 is mounted and the gate 104 forms a platform.

In operation, a user opens lid 152 and loads landscaping waste, such as grass clippings from a lawnmower, through opening 150 into the internal compaction chamber 112. The user then actives the system 10, to actuate motor(s) M, which operate gear linkages G to rotate the threaded drive rods 204, moving compaction plate 200 away from internal end wall 108 towards gate 104 and thereby compacting the inserted material against the gate 104. Following compaction, the plate 200 may be reversed by rotating the worm gear drives 204 in the opposite direction to move away from the gate 104 to internal end wall 108 to provide additional space for insertion of waste that may then be similarly compacted. When the internal compaction chamber 112 contains a desired amount, the gate 104 may be opened and the compaction plate 200 advanced to push waste out of the compaction chamber 112 through the gate opening. Where the gate 104 forms a platform in an open position, the platform may serve as a ramp for directing the ejected waste in a desired direction, or may be used to as a shelf for bagging the waste. Where suitable, as where the landscaping waste is cut grass suitable for the production of silage, a bagging assembly may be attached to the platform for the bagging of the waste in suitable bags that can be sealed for the fermentation process.

A liquid repository, such as a catch tray or basin, may be disposed under an installed system 10 to collect any liquids that may be squeezed out of the waste materials during the compaction or unloading processes.

A sensor may be used to trigger an indicator that informs a user when the compaction chamber 112 is at a desired capacity. In some embodiments, the motors may be configured to stop when a certain force is required to rotate the worm gear drives 204, such that the system ceases movement when the internal compaction chamber 112 is full, (indicated by the load on the motors M) prompting the user to empty the chamber 112.

In contrast to some known compactors, compactor system 10 operates in a horizontal position and uses one or more threaded rods to compress the waste material. The use of a threaded rod to push or pull materials allows for more flexibility and a shorter unit for pushing when compared to a hydraulic cylinder which is limited to a stroke length of twice the un-actuated length. Additionally, the system allows for removing the compacted material using the same motion used to compact the materials in the compactor chamber. Should the compactor become blocked or jammed, the gate 104 can simply be opened and the system actuated to remove the block.

The use of a threaded drive rod 204 drives allows the overall length of the system to nearly equal the “stroke” of the threaded rod making it more compact than any piston type currently known to the inventor. This results in a higher overall length to mass carrying capacity than the prior art devices. Additionally, it has a lower weight ratio due to the use of a threaded rod instead of a hydraulic piston. Potential issues with spillage of hydraulic fluid are similarly avoided.

In a typical installation, the mechanical chamber 110 is installed towards the firewall of a pickup bed, with rear end 106 adjacent to the firewall. Gate 104 would be closest to the tailgate of a pickup, with sides 102 parallel to the truck bed sidewalls.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

What is claimed is:

1. A portable compactor for landscape waste, comprising
a generally rectangular box, extending from a gate at a front end to a closed second end;
an internal compaction chamber defined by the gate and two box sidewalls;
a compaction plate disposed inside the box within the internal compaction chamber;
at least one threaded rod extending along a side of the internal compaction chamber in a generally horizontal direction and disposed through the compaction plate, such that rotation of the threaded rod in a first direction moves the compaction plate towards the gate, and rotation of the threaded rod in second direction moves the compaction plate away from the gate.

2. The portable compactor of claim 1, wherein the at least one threaded rod extending along a side of the internal compaction chamber in a generally horizontal direction and disposed through the compaction plate comprises at least one worm gear drive rod.

3. The portable compactor of claim 1, wherein the at least one threaded rod extending along a side of the internal compaction chamber in a generally horizontal direction and disposed through the compaction plate comprises at least one threaded rod disposed in bearings located at either end of the internal compaction chamber.

4. The portable compactor of claim 1, wherein the at least one threaded rod extending along a side of the internal compaction chamber in a generally horizontal direction and disposed through the compaction plate comprises at least two parallel threaded rods disposed on opposite sides of the internal compaction chamber parallel to a long axis of the internal compaction chamber.

5. The portable compactor of claim 4, wherein the at least two parallel threaded rods comprises four parallel threaded rods with two rods disposed on each opposite side of the internal compaction chamber.

6. The portable compactor of claim 1, wherein the at least one threaded rod is disposed in a channel formed in a sidewall of the internal compaction chamber.

7. The portable compactor of claim 6, wherein the compaction plate further comprises at least one tab extending outwards therefrom in a direction parallel to a front face of the compaction plate and the at least one threaded rod extends through a threaded receiver disposed in a hole in the at least one tab.

8. The portable compactor of claim 6, further comprising a shield member formed as a planar member attached to the compaction plate near a side of a front face thereof and extending therefrom in a direction orthogonal to the front face of the compaction plate the shield member positioned over the channel formed in the at least one sidewall of the internal compaction chamber, such that the shield member covers a portion of the channel in front of the compaction plate during movement of the compaction plate.

9. The portable compactor of claim 1, wherein the at least one threaded rod extending along a side of the internal compaction chamber in a generally horizontal direction and disposed through the compaction plate is configured so that rotation of the threaded rod in a first direction produces a force that pulls the compaction plate towards the gate.

10. The portable compactor of claim 1, further comprising at least one motor operatively connected to the at least one threaded rod, such that actuation of the motor causes the at least one threaded rod to rotate.

11. The portable compactor of claim 10, wherein the at least one motor is operatively connected to the at least one threaded rod by a chain drive attached to sprockets on the sat least one motor and at least one rod.

12. The portable compactor of claim 10, wherein the at least one motor is an electric motor.

13. The portable compactor of claim 1, wherein the gate at the front end is connected to the compactor by at least one hinge disposed at an lower end thereof and at least one retaining latch, such that the latch may be disconnected and the gate rotated downwards to open the internal compaction chamber and the compaction plate moved forward to eject compacted waste from the internal compaction chamber.

14. The portable compactor of claim 13, further comprising at least one leg rotatably attached to the gate to support the gate upon opening to form a shelf over which waste is ejected.

15. A portable horizontal compactor for landscape waste, comprising
a generally rectangular box with an openable gate at a front end and a closed opposite second end;
an internal compaction chamber defined by the gate and two box sidewalls;
a compaction plate disposed inside the box within the internal compaction chamber;
at least a first set of two threaded rods, each threaded rod extending along a box sidewall defining the internal compaction chamber and disposed through the compaction plate, such that rotation of each threaded rod in a first direction moves the compaction plate towards the gate, and rotation of each threaded rod in second direction moves the compaction plate away from the gate.

15. The portable horizontal compactor of claim 14, further comprising a second set of two threaded rods, each threaded rod extending along a box sidewall defining the internal compaction chamber and disposed through the compaction plate, such that there are two threaded rods extending along each box sidewall defining the internal compaction chamber and disposed through corresponding threaded holes in the compaction plate.

16. The portable horizontal compactor of claim 14, wherein each threaded rod is disposed in bearings located at either end of the internal compaction chamber.

17. The portable horizontal compactor of claim 14, wherein each threaded rod is disposed in a corresponding channel formed in a sidewall of the internal compaction chamber.

18. The portable horizontal compactor of claim 17, wherein the compaction plate further comprises a set of tabs extending outwards therefrom in a direction parallel to a front face of the compaction plate and each tab of the set of tabs extends into a corresponding channel and contains a threaded receiver through which the threaded rod disposed in the channel extends through the compaction plate is disposed therein.

19. The portable horizontal compactor of claim 17, further comprising a set of shield members, each shield member formed as a planar member attached to the compaction plate near a side of a front face thereof and extending therefrom in a direction orthogonal to the front face of the compaction plate such that each shield member is positioned over a corresponding channel formed in the at least one sidewall of the internal compaction chamber, such that each shield member covers a portion of the corresponding channel in front of the compaction plate during movement of the compaction plate.

20. The portable horizontal compactor of claim 14, wherein each threaded rod extending along a side of the internal compaction chamber in a generally horizontal direction and disposed through the compaction plate is configured so that rotation of the threaded rod in a first direction produces a force that pulls the compaction plate towards the gate.
